(19) United States
(12) Patent Application Publication
(10) Pub. No.: US 2003/0018485 A1
(43) Pub. Date: Jan. 23, 2003

(54) Publication distribution method

(76) Inventor: Kaye Sullivan, SE Calgary (CA)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 09/909,628

(22) Filed: Jul. 19, 2001

(51) Int. Cl. G06F 17/60

(52) U.S. Cl. 705/1

(57) ABSTRACT

A method of distribution of new book publications includes the placement of such books on sale in each of a variety of selected countries in sequence. In each venue, the books are placed on sale for a limited period of time and are then taken off-sale. The books are not on sale in more than one venue at a time and distribution within each venue terminates prior to the start of the next on sale event in the next country. Only a limited edition of each book is printed. Only the unsold portion of each book is placed on sale at each next venue in the sequence.

### BACKGROUND OF THE INVENTION

1. Field of the Invention

This invention relates generally to the publishing industry and more particularly to an improved method of book publishing.

2. Description of Related Art

The following references teach aspects related to the invention:

U.S. 615158, U.S. Pat. No. 5,657,453, U.S. Pat. No. 4,887,218, U.S. Pat. No. 5,835,377, U.S. 581932, U.S. Pat. No. 6,049,774 and U.S. Pat. No. 5,946,662.

In conventional book publishing, each month, a variety of new books, and indeed other publications, are produced. In order to fulfill an anticipated desire for such new publications, a projected sales estimate is made and the requisite number of books are printed. Such a printing is then distributed to the sales venues of interest, within states, countries, regions, and so on. Shortly after the publication date, these books appear on the shelves of bookstores and in catalogs. New books are published each month, and it is a fact that the current crop of books must be removed from sale to make room for the new ones. The type of books that falls within this business model, are the, novels produced by publishers such as Harlequin and similar publishers. These novels are generally love stores, or adventure or thrill publications. They have little value as literature, but appeal to readers who seek new stories of this type on a continuing basis. Therefore, new titles must appear each month to satisfy this market. Thus, on a monthly basis, approximately 20-30% of these books are trashed, a major financial loss.

The prior art teaches the method of releasing certain fiction story books on a regular basis, i.e., monthly, and of trashing remaining portions of a given publication at the end of each month, for example. The conventional method does not teach the use of unsold new publications in a series of venues such that only a portion of a total printing need be prepared at one time, with the balance printed to match demonstrated demand in the market. The present invention fulfills these needs and provides further related advantages as described in the following summary.

### SUMMARY OF THE INVENTION

The present invention teaches certain benefits in construction and use which give rise to the objectives described below.

A method of distribution of new book publications includes the placement of such books on sale in each of a variety of selected countries in sequence. In each venue, the books are placed on sale for a limited period of time and are then taken off-sale. The books are not on sale in more than one venue at a time and distribution within each venue terminates prior to the start of the next on sale event in the next country. Only a limited edition of each book is printed. Only the unsold portion of each book is placed on sale at each next venue in the sequence. Ongoing printing, for replenishment of sold stock, of a given title is completed based upon current sales to date.

A primary objective of the present invention is to provide a method of book publishing that provides advantages not taught by the prior art.

Another objective is to provide such an invention capable of assuring improved sales results with less waste of unsold publications.

A further objective is to provide such an invention capable of drastic reduction in the cost of a publication.

A still further objective is to provide such an invention capable of improved and heightened public anticipation of the release of a new publication that has been well received in other countries.

Other features and advantages of the present invention will become apparent from the following more detailed description, taken in conjunction with the accompanying drawings, which illustrate, by way of example, the principles of the invention.

### DETAILED DESCRIPTION OF THE INVENTION

The above described drawing figures illustrate the invention in at least one of its preferred embodiments, which is further defined in detail in the following description.

The present invention is a method of publishing or public distribution of printed matter. The method comprises certain steps which are not, in themselves, novel, however, it is the combination of steps which defines a novel method of publishing that provides certain benefits and advantages as defined above, that is novel. A quantity of a plurality of new printed matter, which will be referred to as “books,” is assembled and made ready for public sale, i.e., printed, bound, etc. The books are then shipped to a selected sales venue. In the present invention, the venue is preferably a country within which the books are distributed to selected book sellers and book stores. The books are then presented in conventional ways for sale and maintained for sale over a selected period of time, such as for one month. When the selected period of time has expired, the unsold portion of the books is shipped to a further selected sales venue, or country and the process of display and sale is repeated. This process is again repeated sequentially for a variety of venues. In each venue the placing of the books on sale is a premier publishing event.

It should be recognized that the books are placed on sale for the first time in each venue and held on sale for only a selected period of time. The books are then taken off-sale entirely in each venue, usually monthly, when the time on sale has expired and therefore the books are not thereafter available for sale in the expired venue, except by special order or by mail-order, for instance.

Expressed in an alternative manner, the inventive method of public distribution of printed matter, comprises the steps of: establishing a plurality of publication sales venues represented by V1, V2, V3 . . . ; distributing a plurality of publications on a fixed recurring schedule such that P1, P2, P3 . . . represent the plurality of publications distributed at times 1, 2, 3 . . . respectively; placing Px on sale sequentially at the Vy where x takes on the values of 1, 2, 3 . . . in turn and y distinguishes the venues.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A method of public distribution of printed matter, the method comprising the steps of: assembling a quantity of a plurality of new printed matter ready for public sale; shipping the new printed matter to a selected sales venue; displaying for sale, the new printed matter, at the selected sales venue, for a selected period of time; shipping all of an unsold portion of the new printed matter to a further selected sales venue; displaying, the unsold portion of the new printed matter, at the further selected sales venue, for the selected period of time; selling the unsold portion of the new printed matter; repeating the steps of shipping, displaying and selling of each consecutive unsold portion of the new printed matter for plural selected sales venues.

2. The method of claim 1 wherein the printed matter is books.

3. The method of claim 1 wherein the sales venues are countries.

4. The method of claim 3 wherein the shipping, displaying and selling of the unsold portion of the new printed matter is a premier publishing event within each of the selected sales venues.

5. The method of claim 1 wherein the displaying is executed at bookstores.

6. The method of claim 1 wherein the selected period of time is for approximately one month.

7. A method of distribution of publications comprising the steps of: establishing a plurality of publication sales venues represented by V1, V2, V3 . . . ; distributing a plurality of publications on a fixed recurring schedule such that P1, P2, P3 . . . represent the plurality of publications distributed at times 1, 2, 3 . . . respectively; placing Px on sale sequentially at the Vy where x takes on the values of 1, 2, 3 . . . in turn and y distinguishes the venues.
